(19) United States
(12) Patent Application Publication
(10) Pub. No.: US 2018/0211027 A1
(43) Pub. Date: Jul. 26, 2018

(54) PASSWORD SETTING METHOD AND DEVICE

(71) Applicant: BEIJING KINGSOFT INTERNET SECURITY SOFTWARE CO., LTD., BEIJING (CN)

(72) Inventor: Zubin YU, BEIJING (CN)

(21) Appl. No.: 15/745,370

(22) PCT Filed: Sep. 6, 2016
(86) PCT No.: PCT/CN2016/098159

§ 371 Date: Jan. 16, 2018

(30) Foreign Application Priority Data
Jul. 21, 2015 (CN) 201510431096.1

(51) Int. Cl. G06F 21/36; G06F 21/46; G06F 3/0481

(52) U.S. Cl. CPC G06F 21/36; G06F 3/04817; G06F 21/46

(57) ABSTRACT

The present disclosure provides a password setting method and device. The method includes: displaying a password setting page including a preset number of picture display areas to a user; displaying a picture selected by the user in the picture display area of the password setting page according to a picture selection operation of the user; collecting a touch track of the user with regard to the picture display areas; and setting a password according to identifiers of the picture display areas recorded in collected touch track and the order in which the respective picture display areas appear in the touch track.

### CROSS-REFERENCE TO RELATED APPLICATIONS

This application is a US national phase application of International Application No. PCT/CN2016/098159, filed on Sep. 6, 2016, which is based on and claims priority to and benefits of Chinese Patent Application No. 201510431096.1, filed with the State Intellectual Property Office of P. R. China on Jul. 21, 2015, and titled with “password setting method and device”, the entire contents of which are incorporated herein by reference.

### FIELD

The present disclosure relates to a field of software technology, and more particularly, to a password setting method and a password setting device.

### BACKGROUND

With the rapid development of hardware technology, terminals with touch screens are becoming more and more popular with the majority of users. However, when the user uses the terminal with the touch screen, it is easy to start the terminal device without the user's knowledge due to misoperation or other reasons. Therefore, the user may usually set the password for the terminal device to reduce this occurrence.

In the related art, one way to set the password for the terminal device is to set a digital password through a soft keyboard that includes ten numbers from 0 to 9, and another way is to set a graphical password through a nine-grid screen formed by nine circles or squares. However, whether it is through the soft keyboard to set the digital password, or it is through the nine-grid screen to set the graphical password, after the setting is completed, and when the user enters the password to unlock the terminal device, an interface displayed to the user may be the same to that displayed to other users, which cannot satisfy personalized requirement of the user.

### SUMMARY

Embodiments of the present disclosure provide a password setting method, which is applied to a terminal with a touch screen. The method includes: displaying a password setting page including a preset number of picture display areas to a user; displaying a picture selected by the user in the picture display area of the password setting page according to a picture selection operation of the user; collecting a touch track of the user with regard to the picture display areas; and setting a password according to an identifier of each picture display area recorded in collected touch track and an order in which respective picture display areas appear in the touch track.

Embodiments of the present disclosure provide a password setting device, which is applied to a terminal with a touch screen. The device includes: a password setting page displaying module, a first picture displaying module, a touch track collecting module and a password setting module.

The password setting page displaying module is configured to display a password setting page including a preset number of picture display areas to a user.

The first picture displaying module is configured to display a picture selected by the user in the picture display area of the password setting page according to a picture selection operation of the user.

The touch track collecting module is configured to collect a touch track of the user with regard to the picture display areas.

The password setting module is configured to set a password according to an identifier of each picture display area recorded in collected touch track and an order in which respective picture display areas appear in the touch track.

Embodiments of the present disclosure provide a terminal. The terminal includes a processor, a memory, a communication interface, a bus and a touch screen. The processor, the memory, the communication interface and the touch screen are connected via the bus and communicate with each other. The memory is configured to store executable program codes. The processor is configured to run a program corresponding to the executable program codes by reading the executable program codes stored in the memory, so as to perform a password setting method as described in above embodiments of the present disclosure.

Embodiments of the present disclosure provide a storage medium. The storage medium is configured to store application programs. The application programs are configured to perform the password setting method described above when executed.

In order to achieve the above object, embodiments of the present disclosure provide an application program. The application program is configured to perform the password setting method described above when it is executed.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings can be obtained according to these drawings without creative labor.

FIG. 1 is a first flow chart of a password setting method according to an embodiment of the present disclosure.

FIG. 2 is a schematic diagram of a first password setting page according to an embodiment of the present disclosure.

FIG. 3 is a schematic diagram of a second password setting page according to an embodiment of the present disclosure.

FIG. 4 is a schematic diagram of a third password setting page according to an embodiment of the present disclosure.

FIG. 5 is a schematic diagram of a fourth password setting page according to an embodiment of the present disclosure.

FIG. 6 is a schematic diagram of a fifth password setting page according to an embodiment of the present disclosure.

FIG. 7 is a second flow chart of a password setting method according to an embodiment of the present disclosure.

FIG. 8 is a schematic diagram of a password setting page including a picture editing area according to an embodiment of the present disclosure.

FIG. 9 is a third flow chart of a password setting method according to an embodiment of the present disclosure.

FIG. 10 is a first block diagram of a password setting device according to an embodiment of the present disclosure.

FIG. 11 is a second block diagram of a password setting device according to an embodiment of the present disclosure.

FIG. 12 is a block diagram of a terminal according to an embodiment of the present disclosure.

### DETAILED DESCRIPTION

Reference will be made clearly and completely to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within the scope of the present disclosure.

FIG. 1 is a first flow chart of a password setting method according to an embodiment of the present disclosure. The method is applied to a terminal with a touch screen, and includes follows.

At block S101, a password setting page including a preset number of picture display areas is displayed to a user.

With the rapid development of hardware technology, the performance of the terminal used by the user is becoming more and more powerful, and more and more applications can be supported. Among various applications installed on the terminal of the user, some applications may relate to personal privacy information. Considering factors such as information security, the user usually needs to set a password for an individual application, and the application can be used only after the password is verified.

In addition, when the user carries the terminal, it may cause a misoperation on the terminal due to a collision between the body and the terminal. In view of this situation, the user usually needs to set the password for the terminal.

The password setting method provided by the embodiments of the present disclosure is not only applied to set the password for the application, for example, set a password for an address book, or set a password for a game and so on. The method can further be applied to set a password for the terminal, for example, set a password for a terminal screen lock. The present disclosure is only exemplified by the above examples, and does not limit specific application scenarios.

In actual use, when the user wants to set the password for the application or for the terminal, the terminal needs to display the password setting page to the user first. It should be noted that, in the present disclosure, the password setting page may include the preset number of picture display areas. The picture display area may correspond to a touch area for the user to enter the password, and certainly, may also correspond to a non-touch area, for example, the picture display area is only used for displaying a representative picture. In the process of setting the password, the user can select the picture with regard to the picture display area. In this way, when the user enters the password on a password entry page, the user can see the touch area with the selected pictures as a background, instead of the touch area with the same circles or squares as the background.

In detail, the preset number of picture display areas may be arranged in the password setting page in a picture display area arrangement order preset by the user, and may also be arranged in a default picture display area arrangement order.

In actual use, the terminal may provide the user with multiple picture display area arrangement orders for the user to select, and may set one of these picture display area arrangement orders provided by the terminal as the default arrangement order. When the user does not select, the picture display areas are displayed in the password setting page in the default arrangement order.

In addition, in a preferred implementation, besides the picture display area arrangement orders provided by the terminal, the user can also set the picture display area arrangement order manually.

For example, the above picture display area arrangement order provided by the terminal or the picture display area arrangement order manually set by the user may be a “M” type arrangement order, a “Z” type arrangement order, or a nine-grid type arrangement order.

It should be noted that, the present disclosure does not limit the number of the picture display areas included in the password setting page, for example, the number may be three, five, nine, ten and so on.

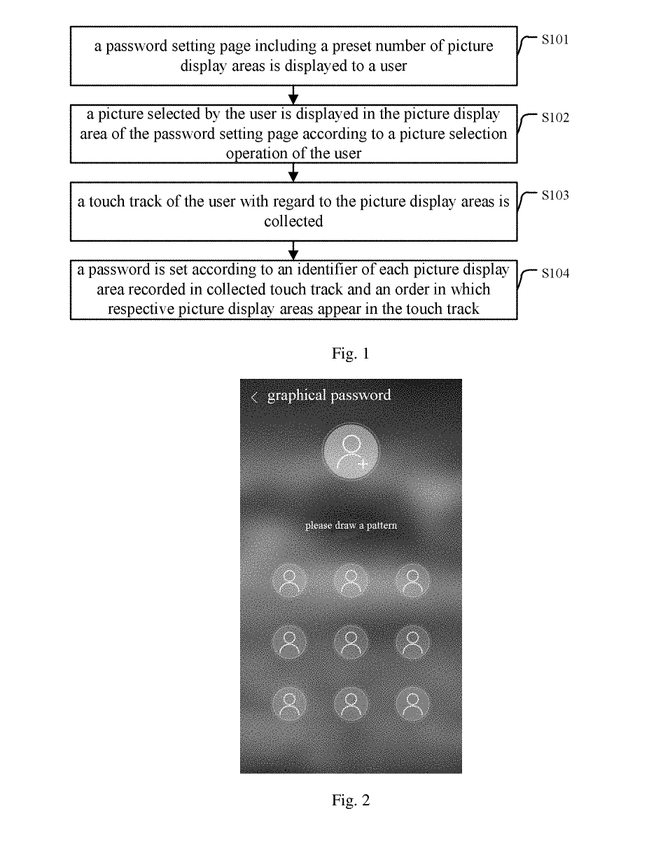

In detail, referring to FIG. 2, a schematic diagram of a password setting page is illustrated.

At block S102, a picture selected by the user is displayed in the picture display area of the password setting page according to a picture selection operation of the user.

In actual use, when the user selects the picture, the picture selection operation of the user may be a selection operation of the user according to a picture list menu, may be a selection operation of the user by dragging the picture displayed in a third picture display area in the password setting page to a fourth picture display area in the password setting page, and may also be a selection operation of the user with regard to the captured image after calling an image capture device to capture image.

In detail, when the picture selection operation of the user is dragging the picture displayed in a third picture display area in the password setting page to a fourth picture display area in the password setting page, it can be understood as displaying the same picture in the third picture display area and the fourth picture display area, and it can also be understood as switching the picture displayed in the third picture display area to the fourth picture display area while leaving the third picture display area blank.

It should be noted that, the present disclosure is only exemplified by the above examples, and in actual use, the picture selection operation of the user is not limited to the above types, and can be determined according to specific circumstances.

It can be seen from the above description that, the password setting page may include multiple picture display areas. In view of this, when the user selects the picture, the user can select the picture with regard to one picture display area each time, and can also select multiple pictures with regard to all the picture display areas at once. Then, the pictures selected respectively according to the above two cases are displayed in the picture display areas. Therefore, this block may be implemented in multiple ways, which are described respectively in follows.

In an alternative implementation of the present disclosure, while selecting each picture, the user may set the picture display area corresponding to this picture in the password setting page. In other words, the picture selection operation of the user may include information of the pictures selected by the user, and may also include information of the picture display area corresponding to each selected picture in the password setting page.

In detail, the pictures selected by the user and the picture display area corresponding to each selected picture in the password setting page can be determined according to the picture selection operation of the user, and then each picture is displayed in the picture display areas corresponding to this picture.

The user may select one picture in one picture selection operation, or may select multiple pictures in one picture selection operation. One picture may correspond to one picture display area in the password setting page, or may correspond to multiple picture display areas in the password setting page.

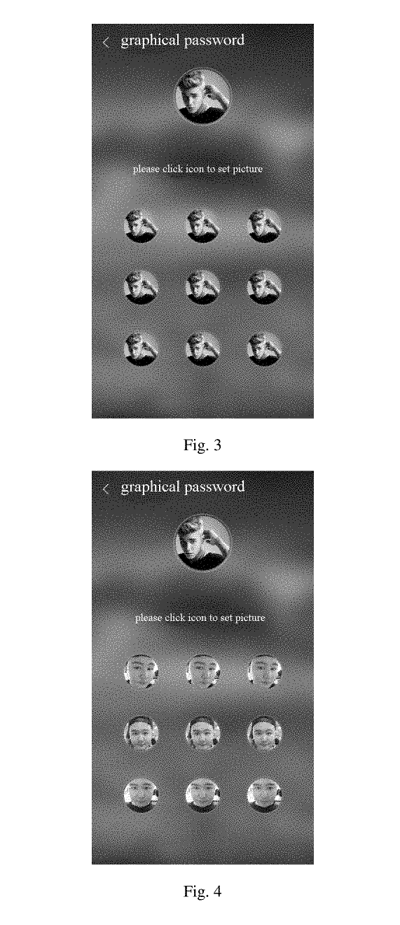

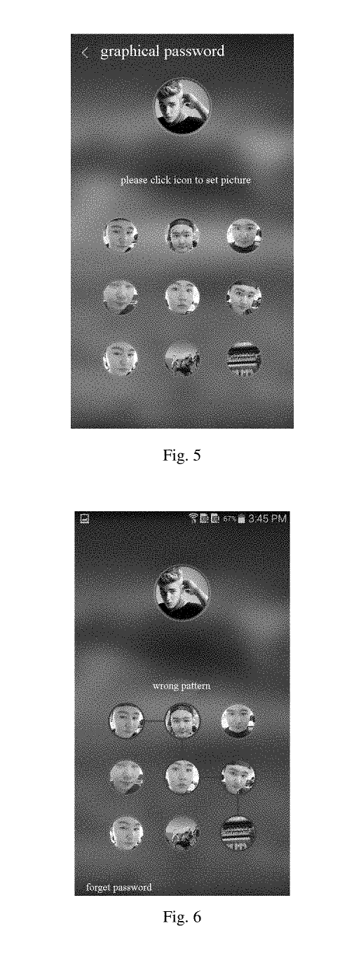

In detail, referring to FIG. 3, FIG. 4 and FIG. 5, schematic diagrams of a password setting page are illustrated.

FIG. 3 is the schematic diagram of the password setting page when the user selects one picture, in which, the picture display areas corresponding to this picture in the password setting page include all the picture display areas in this page. In this case, it can be from FIG. 3 that, the picture displayed in the picture display areas corresponding to the touch area for the user to enter the password (the picture display areas of the nine-grid type) is same as the picture displayed in the picture display area corresponding to the non-touch area for displaying the representative picture (the picture display area above the picture display areas of the nine-grid type).

FIG. 4 is the schematic diagram of the password setting page when the user selects four pictures, in which, the picture display areas corresponding to the four pictures in the password setting page are different. It can be seen from FIG. 4 that, the picture display areas corresponding to three of the four pictures respectively are three rows of picture display areas in the touch area for the user to enter the password (the picture display areas of the nine-grid type), and the picture display area corresponding to the other one picture is the picture display area corresponding to the non-touch area for displaying the representative picture (the picture display area above the picture display areas of the nine-grid type).

FIG. 5 is the schematic diagram of the password setting page when the user selects ten pictures, in which, the picture display areas corresponding to respective pictures in the password setting page are different. It can be seen from FIG. 5 that, the pictures displayed in respective picture display areas corresponding to the touch area for the user to enter the password (the picture display areas of the nine-grid type) and the picture displayed in the picture display area corresponding to the non-touch area for displaying the representative picture (the picture display area above the picture display areas of the nine-grid type) are different from each other.

In another alternative implementation of the present disclosure, the user may perform one picture selection operation with regard to each picture display area in the password setting page, and then the picture selected by the user with regard to the picture display area can be displayed in this picture display area.

For example, referring to FIG. 2, the user can click a “person” pattern in the picture display area to select the picture for this area, and then the picture selected by the user can be displayed in this area. At this point, displaying the picture selected by the user in one picture display area is completed, and the user can repeat above process until the pictures selected by the user are displayed in all the picture display areas.

In another alternative implementation of the present disclosure, while selecting each picture, the user may not set the picture display areas corresponding to this picture in the password setting page. Instead, the picture display area corresponding to each selected picture may be determined according to a certain picture display rule while displaying the pictures. The picture display rule may be selected by the user from various picture display rules, may be a default picture display rule, or may also be determined from various picture display rules according to a random function.

In detail, the pictures selected by the user can be determined according to the picture selection operation of the user, and then the picture display areas corresponding to each picture selected by the user in the password setting page are determined according to the preset picture display rule, and finally the pictures selected by the user are displayed in the determined picture display areas.

The preset picture display rule is configured to represent a correspondence relationship between the picture selected by the user and the picture display area.

In at least one embodiment, the preset picture display rule may be related to an order in which the user selects the pictures, and may also be related to resolution of the selected pictures, which is not limited in the present disclosure.

In addition, in actual use, although the password setting page may include multiple picture display areas, the user may not necessarily select the picture for each picture display area when the user sets the password, and some picture display areas may be blank.

At block S103, a touch track of the user with regard to the picture display areas is collected.

The touch track may be understood as a sliding track formed by the user sliding on a screen through fingers, stylus or the like, and may also be understood as a click track formed by the user clicking on the screen through fingers, stylus or the like.

In the present embodiment, the touch track of the user with regard to the picture display areas may be collected only once, and then the password is set according to the collected touch track.

In at least one embodiment, the touch track of the user with regard to the picture display areas may be collected multiple times. When the touch track is collected multiple times, the accuracy of the touch track via which the user sets the password can be guaranteed greatly, however, this requires the user to input the touch track multiple times, which is easy to make a tedious impression on the user, and results in poor user experience.

In at least one embodiment, the touch track of the user with regard to the picture display area is collected twice.

In detail, referring to FIG. 6, a schematic diagram of a password setting page is illustrated. In FIG. 6, the track marked with dark line is the touch track of the user with regard to the picture display areas.

At block S104, a password is set according to an identifier of each picture display area recorded in collected touch track and an order in which respective picture display areas appear in the touch track.

In at least one embodiment, in a case where the touch track of the user with regard to the picture display area is collected at least twice, when the password is set according to the identifier of each picture display area recorded in collected touch track and an order in which respective picture display areas appear in the touch track, it is possible to determine whether the identifiers of the picture display areas recorded in sequence in one collected touch track are consistent respectively with those in another collected touch track according to a touch order of the user with regard to the touch track of the picture display areas. When it is determined that they are consistent, the password can be set according to the identifiers of the picture display areas recorded in the touch track collected at any time and the order in which respective picture display areas appear in the touch track.

In the case where the touch track is the sliding track, the touch order described above can be understood as the order of sliding through respective picture display areas.

In the case where the touch track is the click track, the touch order described above can be understood as the order of clicking respective picture display areas.

In an implementation of the present disclosure, when the above method is applied to set the password, the representative picture of the application that needs to set with the password currently can be obtained, and then the representative picture can be displayed at a preset location in the password setting page.

The preset location may be located above the picture display areas in the password setting page, and certainly, may also be located in other locations, which is not limited in the present disclosure.

It should be noted that, obtaining the representative picture and displaying the representative picture may be performed before displaying the pictures selected by the user in the picture display areas of the password setting page according to the picture selection operation of the user, and may also be performed after that. The present disclosure does not limit the execution order of above operations.

It should be understood by those skilled in the art that, the above representative picture may also be set manually by the user.

The above-described embodiments are obviously solutions for setting the password for the application. Similarly, when setting the password for the terminal, it is possible to select a representative picture for the terminal by the way of selecting the picture by the user and to display the representative picture at a preset location, for example, above the picture display areas in the password setting page.

As described above, with technical solutions provided by embodiments of the present disclosure, when the password is set, before the touch track is collected and the password is set according to the collected touch track, the pictures are selected first according to the picture selection operation of the user, and the pictures selected by the user are displayed in the picture display areas of the password setting page. After the password is set using the technical solutions provided by embodiments of the present disclosure, the page to be seen when the user enters the password may vary due to different pictures selected by the user, thereby having distinct personalized features.

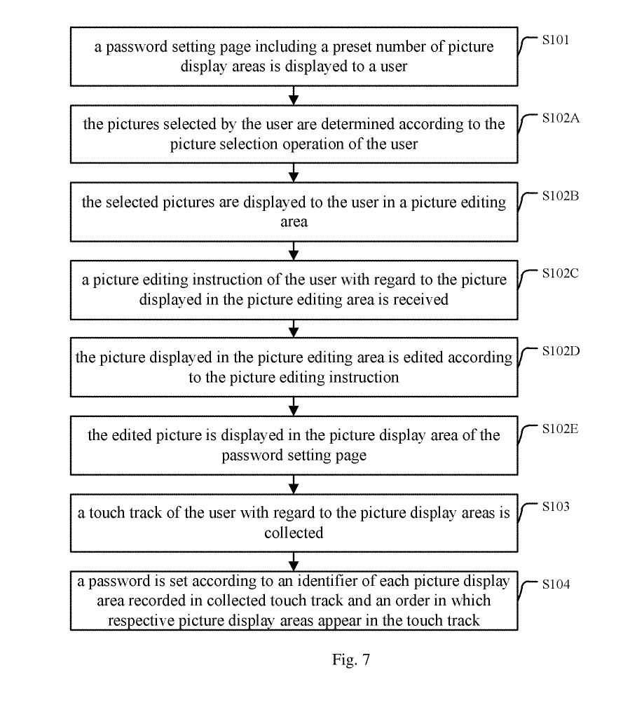

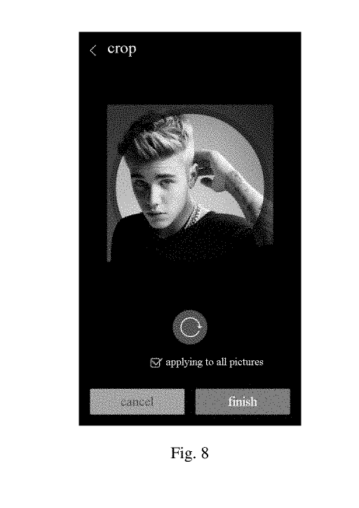

In an implementation of the present disclosure, referring to FIG. 7, a second flow chart of a password setting method is illustrated. Compared with the foregoing embodiments, in the present embodiment, the act of displaying the pictures selected by the user in the picture display areas of the password setting page according to the picture selection operation of the user (S102) may include follows.

At block S102A, the pictures selected by the user are determined according to the picture selection operation of the user.

The determined pictures selected by the user may include one picture, and may also include multiple pictures, which is not limited in the present disclosure.

At block S102B, the selected pictures are displayed to the user in a picture editing area.

When the user selects multiple pictures at block S102A, one or more pictures may be displayed at one time according to the screen size of the terminal, and the pictures that are not displayed at this time can be displayed by switching the screen.

At block S102C, a picture editing instruction of the user with regard to the picture displayed in the picture editing area is received.

The picture editing instruction may include information such as a clipping coefficient, a scale-up factor, a scale-down factor, moving distance to up, down, left and right, an identifier of color processing mode, an identifier of picture beautification processing and so on. The present disclosure is only exemplified by the above examples, and the information included in the picture editing instruction is not limited thereto.

At block S102D, the picture displayed in the picture editing area is edited according to the picture editing instruction.

In detail, when the picture displayed in the picture editing area is edited according to the picture editing instruction, a layer of which the middle area is blank may be covered on the picture editing area. The blank area in the layer may be round, square, oval etc. The picture is adjusted such as scaled and shifted according to information included in the picture editing instruction, and a picture content finally located in the blank area is the content to be displayed in the picture display area. In addition, it should be noted that, the location of the layer will not change in the process of editing the picture according the picture editing instruction.

Further, in order to obtain a good picture editing effect, when the picture is edited, the picture may be scaled uniformly to prevent deformation of the picture. The scale-up or scale-down factor of the picture may be defined. For example, when the picture is scaled down, a short edge of the scaled picture is not less than a diameter of the above round middle area, and when the picture is scaled up, the short edge of the scaled picture can be scaled up to three times of the original length, thus preventing the picture displayed in the picture display area from being too small or virtual. When the picture is dragged, it can also be defined that the edge of the picture cannot be dragged to the above middle area, thus ensuring that the content displayed in the picture display area is full.

In detail, referring to FIG. 8, a schematic diagram of a password setting page including a picture editing area is illustrated.

At block S102E, the edited picture is displayed in the picture display area of the password setting page.

As described above, with technical solutions provided by embodiments of the present disclosure, when the picture selected by the user is displayed in the picture display area of the password setting page according to the picture selection operation of the user, the selected picture is first edited according to the picture editing instruction of the user, and then the edited picture is displayed in the picture display area. After the password is set according to technical solutions provided by embodiments of the present disclosure, it is possible to display a more personalized interface to the user in the password entry page.

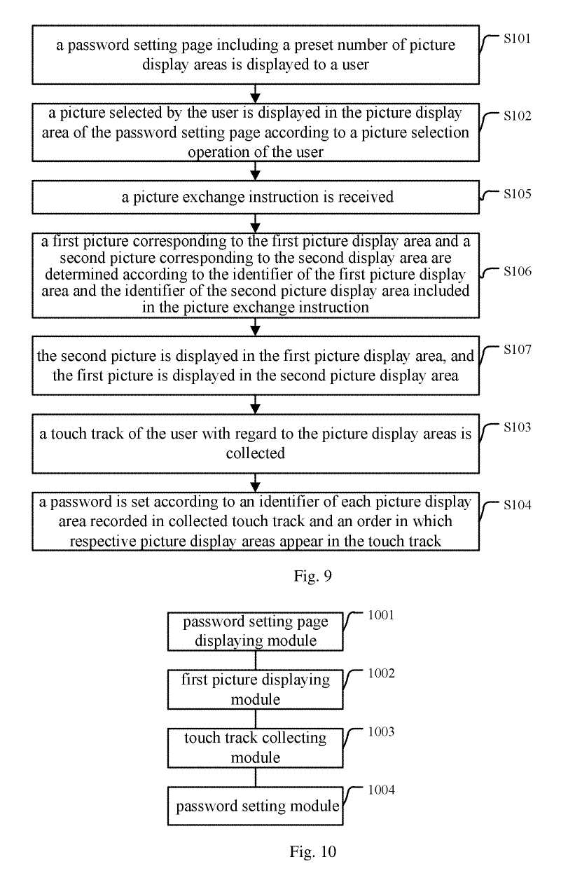

In another implementation of the present disclosure, referring to FIG. 9, a third flow chart of a password setting method is illustrated. Compared with the foregoing embodiments, in the present embodiment, after the act of displaying a picture selected by the user in the picture display area of the password setting page according to a picture selection operation of the user (S102), the password setting method further include followings.

At block S105, a picture exchange instruction is received.

The picture exchange instruction includes an identifier of a first picture display area to perform picture exchange and an identifier of a second picture display area to perform picture exchange.

At block S106, a first picture corresponding to the first picture display area and a second picture corresponding to the second display area are determined according to the identifier of the first picture display area and the identifier of the second picture display area included in the picture exchange instruction.

It should be noted that, when the first picture display area or the second picture display area does not display the picture, the determined first picture or the second picture may be blank.

At block S107, the second picture is displayed in the first picture display area, and the first picture is displayed in the second picture display area.

Assuming that the first picture determined in block S106 is blank, and the second picture determined in block S106 is picture A, then at this block, the picture A is displayed in the first picture display area, and the second picture display area does not display any picture.

As can be seen from the above, with technical solutions provided by embodiments of the present disclosure, respective picture displayed in the picture display areas can be exchanged according to the picture exchange instruction, and the user does not need to select pictures according to the picture selection operation, thereby facilitating user operation, saving user time, and improving user experience.

Corresponding to the password setting method described above, embodiments of the present disclosure further provide a password setting device.

FIG. 10 is a first block diagram of a password setting device according to an embodiment of the present disclosure. The device is applied to a terminal with a touch screen, and includes a password setting page displaying module 1001, a first picture displaying module 1002, a touch track collecting module 1003 and a password setting module 1004.

The password setting page displaying module 1001 is configured to display a password setting page including a preset number of picture display areas to a user.

The first picture displaying module 1002 is configured to display a picture selected by the user in the picture display area of the password setting page according to a picture selection operation of the user.

The touch track collecting module 1003 is configured to collect a touch track of the user with regard to the picture display areas.

The password setting module 1004 is configured to set a password according to an identifier of each picture display area recorded in collected touch track and an order in which respective picture display areas appear in the touch track.

In an implementation of the present disclosure, the first picture displaying module 1002 may include a picture and area determining sub-module and a second picture displaying sub-module.

The picture and area determining sub-module is configured to determine the picture selected by the user and the picture display area corresponding to the picture selected in the password setting page according to the picture selection operation of the user.

The second picture displaying sub-module is configured to display the picture in the picture display area corresponding to the picture selected by the user.

In another implementation of the present disclosure, the first picture displaying module 1002 is specifically configured to, according to the picture selection operation of the user with regard to each picture display area in the password setting page, display the picture selected by the user with regard to the picture display area in the picture display.

In another implementation of the present disclosure, the first picture displaying module 1002 may include a second picture determining sub-module, a display area determining sub-module and a third picture displaying sub-module.

The second picture determining sub-module is configured to determine the picture selected by the user according to the picture selection operation of the user.

The display area determining sub-module is configured to determine the picture display area corresponding to the picture selected by the user in the password setting page according to a preset picture display rule, in which, the preset picture display rule is configured to represent a correspondence relationship between the picture selected by the user and the picture display area.

The third picture displaying sub-module is configured to display the picture selected by the user in the determined picture display area.

Alternatively, the password setting device may further include a picture exchange instruction receiving module, a picture determining module and a second picture displaying module.

The picture exchange instruction receiving module is configured to receive a picture exchange instruction, in which, the picture exchange instruction includes an identifier of a first picture display area to perform picture exchange and an identifier of a second picture display area to perform picture exchange.

The picture determining module is configured to determine a first picture corresponding to the first picture display area and a second picture corresponding to the second display area according to the identifier of the first picture display area and the identifier of the second picture display area included in the picture exchange instruction.

The second picture displaying module is configured to display the second picture in the first picture display area, and display the first picture in the second picture display area.

In an embodiment of the present disclosure, the picture selection instruction of the user may be a selection operation of the user according to a picture list menu, or a selection operation of the user by dragging the picture displayed in a third picture display area in the password setting page to a fourth picture display area in the password setting page, or a selection operation of the user with regard to capture image after calling an image capture device to capture image.

Alternatively, the password setting page displaying module 1001 is specifically configured to display the password setting page including the preset number of picture display areas to the user according to a picture display area arrangement order preset by the user, or display the password setting page including the preset number of picture display areas to the user according to a default picture display area arrangement order.

Alternatively, the password setting device may further include a picture obtaining module and a third picture displaying module.

The picture obtaining module is configured to obtain a representative picture of an application that needs to be set with the password currently.

The third picture displaying module is configured to display the representative picture in a preset picture display area in the password setting page.

In an embodiment of the present disclosure, the touch track collecting module is configured to collect the touch track of the user with regard to the picture display area at least twice.

The password setting module includes an area identifier determining sub-module and a password setting sub-module.

The area identifier determining sub-module is configured to determine whether the identifiers of the picture display areas recorded in sequence in one collected touch track are consistent respectively with those in another collected touch track according to a touch order in which the user inputs the touch track with regard to the picture display areas.

The password setting sub-module is configured to set the password according to the identifiers of the picture display areas recorded in the touch track collected at any time and the order in which respective picture display areas appear in the touch track collected at any time when the determining result of the area identifier determining sub-module is yes.

As described above, with technical solutions provided by embodiments of the present disclosure, when the password is set, before the touch track is collected and the password is set according to the collected touch track, the picture is selected first according to the picture selection operation of the user, and the picture selected by the user is displayed in the picture display area of the password setting page. After the password is set according to technical solutions provided by embodiments of the present disclosure, the page to be seen when the user enters the password may vary due to different pictures selected by the user, thereby having distinct personalized features.

In an embodiment of the present disclosure, referring to FIG. 11, a second schematic diagram of a password setting device is illustrated. Compared with the foregoing embodiments, in the present embodiment, the first picture displaying module 1002 includes a first picture determining sub-module 10021, a picture displaying sub-module 10022, a picture editing instruction receiving sub-module 10023, a picture editing sub-module 10024, and a first picture displaying sub-module 10025.

The first picture determining sub-module 10021 is configured to determine the picture selected by the user according to the picture selection operation of the user.

The picture displaying sub-module 10022 is configured to display the selected picture to the user in a picture editing area.

The picture editing instruction receiving sub-module 10023 is configured to receive a picture editing instruction of the user with regard to the picture displayed in the picture editing area.

The picture editing sub-module 10024 is configured to edit the picture displayed in the picture editing area according to the picture editing instruction.

The first picture displaying sub-module 10025 is configured to display the edited picture in the picture display area of the password setting page.

As described above, with technical solutions provided by embodiments of the present disclosure, when the picture selected by the user is displayed in the picture display area of the password setting page according to the picture selection operation of the user, the selected picture is first edited according to the picture editing instruction of the user, and then the edited picture is displayed in the picture display area. After the password is set according to technical solutions provided by embodiments of the present disclosure, it is possible to display a more personalized interface to the user in the password entry page.

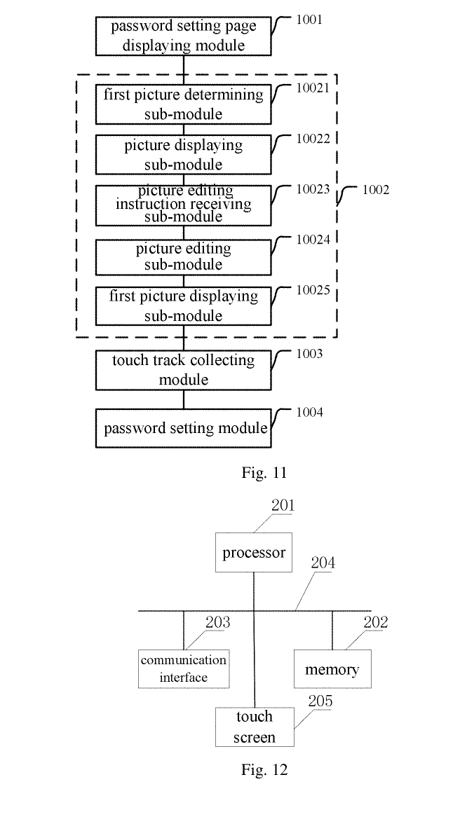

In addition, embodiments of the present disclosure further provide a terminal. As illustrated in FIG. 12, the terminal includes a processor 201, a memory 202, a communication interface 203, a bus 204 and touch screen 205.

The processor 201, the memory 202 and the communication interface 203 are connected via the bus 204 and communicate with each other.

The memory 202 is configured to store executable program codes.

The processor 201 is configured to run a program corresponding to the executable program codes by reading the executable program codes stored in the memory 202, so as to perform a password setting method. The password setting method includes: displaying a password setting page including a preset number of picture display areas to a user; displaying a picture selected by the user in the picture display area of the password setting page according to a picture selection operation of the user; collecting a touch track of the user with regard to the picture display areas; and setting a password according to an identifier of each picture display area recorded in collected touch track and an order in which respective picture display areas appear in the touch track.

As described above, with technical solutions provided by embodiments of the present disclosure, when the password is set, before the touch track is collected and the password is set according to the collected touch track, the picture is selected first according to the picture selection operation of the user, and the picture selected by the user is displayed in the picture display area of the password setting page. After the password is set according to the technical solutions provided by embodiments of the present disclosure, the page to be seen when the user enters the password may vary due to different pictures selected by the user, thereby having distinct personalized features.

In addition, embodiments of the present disclosure provide a storage medium. The storage medium is configured to store application programs. The application program is configured to perform a password setting method when executed. The password setting method is applied to a terminal with a touch screen, and includes: displaying a password setting page including a preset number of picture display areas to a user; displaying a picture selected by the user in the picture display area of the password setting page according to a picture selection operation of the user; collecting a touch track of the user with regard to the picture display areas; and setting a password according to an identifier of each picture display area recorded in collected touch track and an order in which respective picture display areas appear in the touch track.

As described above, with technical solutions provided by embodiments of the present disclosure, when the password is set, before the touch track is collected and the password is set according to the collected touch track, the picture is selected first according to the picture selection operation of the user, and the picture selected by the user is displayed in the picture display area of the password setting page. After the password is set according to the technical solutions provided by embodiments of the present disclosure, the page to be seen when the user enters the password may vary due to different pictures selected by the user, thereby having distinct personalized features.

In addition, embodiments of the present disclosure provide an application program. The application program is configured to perform a password setting method when executed. The password setting method is applied to a terminal with a touch screen, and includes: displaying a password setting page including a preset number of picture display areas to a user; displaying a picture selected by the user in the picture display area of the password setting page according to a picture selection operation of the user; collecting a touch track of the user with regard to the picture display areas; and setting a password according to an identifier of each picture display area recorded in collected touch track and an order in which respective picture display areas appear in the touch track.

As described above, with technical solutions provided by embodiments of the present disclosure, when the password is set, before the touch track is collected and the password is set according to the collected touch track, the picture is selected first according to the picture selection operation of the user, and the picture selected by the user is displayed in the picture display area of the password setting page. After the password is set according to the technical solutions provided by embodiments of the present disclosure, the page to be seen when the user enters the password may vary due to different pictures selected by the user, thereby having distinct personalized features.

For device embodiments, since they are substantially similar to the method embodiments, descriptions of which are relatively simple, and relevant parts can refer to corresponding descriptions of the method embodiments.

It should be noted that, in descriptions of the present disclosure, terms such as “first” and “second” are only used for distinguishing an entity or operation from another entity or operation without necessarily requiring or implying any such actual relationship or order between these entities or operations. Furthermore, terms “comprising”, “containing” or any other variant thereof are intended to cover non-exclusive inclusion, such that the process, the method, the article or the device that includes a series of elements include those elements and other elements that are not listed explicitly, or include elements inherent in the process, the method, the article or the device. Without more restrictions, the elements defined by the phrase “including one . . . ” do not exclude the presence of additional similar elements in the process, the method, the article or the device that including the elements.

It would be understood by those skilled in the art that all or a part of the steps carried by the method in the above-described embodiments may be completed by relevant hardware instructed by a program. The program may be stored in a computer readable storage medium, and the storage medium herein may be ROM/RAM, magnetic disks, CD, etc.

The embodiments described above are merely preferred embodiments of the present disclosure, and is not intended to limit the scope of the present disclosure. Any modifications, equivalent alternatives, improvements and the like without departing from spirit and principles of the present disclosure are within the scope of the present disclosure.

1. A password setting method, applied to a terminal with a touch screen, comprising:
displaying a password setting page comprising a preset number of picture display areas to a user;
displaying a picture selected by the user in the picture display area of the password setting page according to a picture selection operation of the user;
collecting a touch track of the user with regard to the picture display areas; and
setting a password according to an identifier of each picture display area recorded in collected touch track and an order in which respective picture display areas appear in the touch track.

2. The method according to claim 1, wherein, displaying a picture selected by the user in the picture display area of the password setting page according to a picture selection operation of the user comprises:
determining the picture selected by the user according to the picture selection operation of the user;
displaying the selected picture to the user in a picture editing area;
receiving a picture editing instruction of the user with regard to the picture displayed in the picture editing area;
editing the picture displayed in the picture editing area according to the picture editing instruction; and
displaying the edited picture in the picture display area of the password setting page.

3. The method according to claim 1, wherein, displaying a picture selected by the user in the picture display area of the password setting page according to a picture selection operation of the user comprises:
determining the picture selected by the user and the picture display area corresponding to the picture selected in the password setting page according to the picture selection operation of the user; and
displaying the picture in the picture display area corresponding to the picture selected by the user.

4. The method according to claim 1, wherein, displaying a picture selected by the user in the picture display area of the password setting page according to a picture selection operation of the user comprises:
according to the picture selection operation of the user with regard to each picture display area in the password setting page, displaying the picture selected by the user with regard to the picture display area in the picture display area.

5. The method according to claim 1, wherein, displaying a picture selected by the user in the picture display area of the password setting page according to a picture selection operation of the user comprises:
determining the picture selected by the user according to the picture selection operation of the user;
determining the picture display area corresponding to the picture selected by the user in the password setting page according to a preset picture display rule, wherein, the preset picture display rule is configured to represent a correspondence relationship between the picture selected by the user and the picture display area; and
displaying the picture selected by the user in the determined picture display area.

6. The method according to claim 1, wherein, after displaying a picture selected by the user in the picture display area of the password setting page according to a picture selection operation of the user, further comprising:
receiving a picture exchange instruction, wherein, the picture exchange instruction comprises an identifier of a first picture display area to perform picture exchange and an identifier of a second picture display area to perform picture exchange;
determining a first picture corresponding to the first picture display area and a second picture corresponding to the second display area according to the identifier of the first picture display area and the identifier of the second picture display area comprised in the picture exchange instruction; and
displaying the second picture in the first picture display area, and displaying the first picture in the second picture display area.

7. The method according to claim 1, wherein, the picture selection instruction of the user is:
a selection operation of the user according to a picture list menu; or
a selection operation of the user by dragging the picture displayed in a third picture display area in the password setting page to a fourth picture display area in the password setting page; or
a selection operation of the user with regard to captured image after calling an image capture device to capture image.

8. The method according to claim 1, wherein, displaying a password setting page comprising a preset number of picture display areas to a user comprises:
displaying the password setting page comprising the preset number of picture display areas to the user according to a picture display area arrangement order preset by the user; or
displaying the password setting page comprising the preset number of picture display areas to the user according to a default picture display area arrangement order.

9. The method according to claim 1, further comprising:
obtaining a representative picture of an application that needs to be set with the password currently; and
displaying the representative picture in the preset picture display area in the password setting page.

10. The method according to claim 1,
wherein, collecting a touch track of the user with regard to the picture display area comprises:
collecting the touch track of the user with regard to the picture display area at least twice;
wherein, setting a password according to an identifier of the picture display area recorded in collected touch track and an order in which each picture display area appears in the touch track comprises:
determining whether the identifiers of the picture display areas recorded in sequence in one collected touch track are consistent respectively with those in another collected touch track according to a touch order in which the user inputs the touch track with regard to the picture display areas; and
when they are consistent, setting the password according to the identifiers of the picture display areas recorded in the touch track collected at any time and the order in which respective picture display areas appear in the touch track collected at any time.

11. (canceled)

12. A terminal, comprising a processor, a memory, a communication interface, a bus and a touch screen;
the processor, the memory, the communication interface and the touch screen are connected via the bus and communicate with each other;
the memory is configured to store executable program codes;
the processor is configured to run a program corresponding to the executable program codes by reading the executable program codes stored in the memory, so as to:
display a password setting page comprising a preset number of picture display areas to a user;
display a picture selected by the user in the picture display area of the password setting page according to a picture selection operation of the user;
collect a touch track of the user with regard to the picture display areas; and
set a password according to an identifier of each picture display area recorded in collected touch track and an order in which respective picture display areas appear in the touch track.

13. A non-transitory computer readable storage medium, configured to store application programs that, when executed, configured to perform a password setting method, the method comprising:
displaying a password setting page comprising a preset number of picture display areas to a user;
displaying a picture selected by the user in the picture display area of the password setting page according to a picture selection operation of the user;
collecting a touch track of the user with regard to the picture display areas; and
setting a password according to an identifier of each picture display area recorded in collected touch track and an order in which respective picture display areas appear in the touch track.

14. (canceled)

15. The terminal according to claim 12, wherein, the processor is configured to:
determine the picture selected by the user according to the picture selection operation of the user;
display the selected picture to the user in a picture editing area;
receive a picture editing instruction of the user with regard to the picture displayed in the picture editing area;
edit the picture displayed in the picture editing area according to the picture editing instruction; and
display the edited picture in the picture display area of the password setting page.

16. The terminal according to claim 12, wherein, the processor is configured to:
determine the picture selected by the user and the picture display area corresponding to the picture selected in the password setting page according to the picture selection operation of the user; and
display the picture in the picture display area corresponding to the picture selected by the user.

17. The terminal according to claim 12, wherein, the processor is configured to:
according to the picture selection operation of the user with regard to each picture display area in the password setting page, display the picture selected by the user with regard to the picture display area in the picture display area.

18. The terminal according to claim 12, wherein, the processor is configured to:
determine the picture selected by the user according to the picture selection operation of the user;
determine the picture display area corresponding to the picture selected by the user in the password setting page according to a preset picture display rule, wherein, the preset picture display rule is configured to represent a correspondence relationship between the picture selected by the user and the picture display area; and
display the picture selected by the user in the determined picture display area.

19. The terminal according to claim 12, wherein, the processor is further configured to:
receive a picture exchange instruction, wherein, the picture exchange instruction comprises an identifier of a first picture display area to perform picture exchange and an identifier of a second picture display area to perform picture exchange;
determine a first picture corresponding to the first picture display area and a second picture corresponding to the second display area according to the identifier of the first picture display area and the identifier of the second picture display area comprised in the picture exchange instruction; and
display the second picture in the first picture display area, and displaying the first picture in the second picture display area.

20. The terminal according to claim 12, wherein, the processor is configured to:
display the password setting page comprising the preset number of picture display areas to the user according to a picture display area arrangement order preset by the user; or
display the password setting page comprising the preset number of picture display areas to the user according to a default picture display area arrangement order.

21. The terminal according to claim 12, wherein the processor is further configured to:
obtain a representative picture of an application that needs to be set with the password currently; and
display the representative picture in the preset picture display area in the password setting page.

22. The terminal according to claim 12, wherein the processor is configured to:
collect the touch track of the user with regard to the picture display area at least twice;
determine whether the identifiers of the picture display areas recorded in sequence in one collected touch track are consistent respectively with those in another collected touch track according to a touch order in which the user inputs the touch track with regard to the picture display areas; and
when they are consistent, set the password according to the identifiers of the picture display areas recorded in the touch track collected at any time and the order in which respective picture display areas appear in the touch track collected at any time.
